(19) United States
(12) Patent Application Publication
(10) Pub. No.: US 2006/0101177 A1
(43) Pub. Date: May 11, 2006

(54) System with Universal Serial Bus (USB) host functions and its processing methods

(75) Inventor: Dennis Tsai, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: PLUSTEK INC., Taipei (TW)

(21) Appl. No.: 10/957,637

(22) Filed: Oct. 5, 2004

(51) Int. Cl. G06F 13/00

(52) U.S. Cl. 710/100

(57) ABSTRACT

A system with Universal Serial Bus (USB) host functions and its processing method is proposed. This system comprises a printed circuit board, a USB host connected to the printed circuit board, an in-system programming interface device connected to the printed circuit board, a plurality of device ports connected to the printed circuit board, at least one USB host port connected to the printed circuit board, and at least one memory device connected to the printed circuit board, wherein the printed circuit board is used to connect the USB host, the in-system programming interface device, the device ports, the USB host port, and the memory device.

### THE FIELD OF THE INVENTION

This invention is related to an electronic system and its processing method and more particularly to a system with Universal Serial Bus (USB) host functions and its processing method.

### THE BACKGROUND OF THE INVENTION

The Universal Serial Bus (USB) was sold in 1996, but in that period main boards with the USB were not popular in the market. In 1998, the Universal Serial Bus Implementers Forum (USB-IF) proposed the USB 1.1 version. Since there were USB drivers inserted in the Windows 98 SE operation system and the iMac of the Apple company used the USB as a standard interface, the relative applications of the USB have been developed more and more vibrantly to gradually make the USB become one of standard I/O interfaces in a personal computer.

The main disadvantage of the USB 1.1 version is a very low transmittance rate that is only 12 Mbps. Therefore, its application scope is limited to devices that do not require a high transmittance rate, such as mouse, keyboard. The high transmittance rate market was still dominated by the IEEE1394 with 400 Mbps.

On April, 2000, the USB 2.0 version of a transmittance rate, 480 Mbps, was presented. Not only is this version 40 times faster than the USB 1.1 version, but also it overcomes the IEEE 1934 transmittance rate. Therefore, application products are expended from a mouse and keyboard to a scanner and printer gradually. Even digital cameras traditionally using the IEEE 1394 as a main interface start to use the USB 2.0 version.

Because at the beginning the USB was considered an interface between a computer and peripheral devices, the master-servant architecture was selected when the USB-IF drafted the basic architecture of the USB. Some more difficult and complex jobs are delivered to a host, a computer. Thus, the design complexity of USB devices is reduced very much, and manufacturers can design USB devices easily. It is impossible under the USB basic architecture that USB devices are not controlled by a computer and connect with each other; for example, the connection between a digital camera and printer. In the basic USB architecture, there must be one end as a host, so there is no end taken as a host when two USB devices connect with each other. It leads to no connection. To solve this problem, the USB-IF proposed the OTG (On-The-Go) regulation on Dec. 18, 2001. This regulation is for the connection between USB devices. Therefore, the USB can cross the limitation of its relative applications to a personal computer and get into the field of consumer electronic products deeply.

In sum, the traditional USB technology is one computer-to-multi USB devices and one USB device-to-one USB device. For the one computer-to-multi USB devices technology, the USB function can be used on the ground of a whole computer system. Thus, this way of using the USB function is limited by a computer system, such as space, operational software and required hardware. For the one USB device-to-one USB device technology, for example digital camera and printer, when a digital camera transfers data into a printer through a USB interface, the printer can only handle the data from the digital camera. Therefore, after the digital camera finishes its data transfer, the next one USB device can transfer data to the printer.

Therefore, it is desired by enormous users of consumer electronic products that a novel USB technology should be developed to provide a multi USB devices-to multi USB devices technology.

### THE SUMMARY OF THE INVENTION

This invention provides a multi USB devices-to multi USB devices technology to have the USB implemented in a non-personal computer environment and to fulfill requests for the multi USB devices-to multi USB devices technology.

This invention provides a system with Universal Serial Bus (USB) host functions and its processing method. This system comprises a printed circuit board, a USB host connected to the printed circuit board, an in-system programming interface device connected to the printed circuit board, a plurality of device ports connected to the printed circuit board, at least one USB host port connected to the printed circuit board, and at least one memory device connected to the printed circuit board, wherein the printed circuit board is used to connect the USB host, the in-system programming interface device, the device ports, the USB host port, and the memory device.

The system of this invention further comprises a control panel or a USB hub.

The system-processing method of this invention processes a system of this invention. This system comprises a printed circuit board, a USB host connected to the printed circuit board, an in-system programming interface device connected to the printed circuit board, a plurality of device ports connected to the printed circuit board, at least one USB host port connected to the printed circuit board, at least one memory device connected to the printed circuit board, and a control panel, wherein the printed circuit board is used to connect the USB host, the in-system programming interface device, the device ports, the USB host port, and the memory device and the control panel is connected to the printed circuit board.

The system-processing method of this invention mainly comprises the following steps: (a) checking whether the USB host is connected to a outside device; (b) if it is yes at the step (a), reading a manufacturer identification (ID) and product ID of the outside device; (c) checking whether the manufacturer ID and product ID are listed in a codebook stored in the memory device; (d) if it is yes at the step (c), showing the name of the outside device on the control panel.

Other further steps of the system-processing method of this invention will be described later.

The next section will describe other features of this invention. Embodiments in the next section are considered examples and not used to limit this invention. Moreover, devices, procedures, processes, steps, materials, dimensions, structures, applications or other optional parts in the embodiments also do not limit this invention. Besides, this invention is defined as the appended claims.

### THE EMBODIMENTS OF THE INVENTION

This invention provides a system with Universal Serial Bus (USB) host functions to achieve the multi USB devices-to multi USB devices technology.

In one embodiment of this invention, a system 100, shown in FIG. 1, has Universal Serial Bus (USB) host functions. This system comprises a printed circuit board 100, a USB host 120 connected to the printed circuit board, an in-system programming interface device 130 connected to the printed circuit board, a plurality of device ports 140 connected to the printed circuit board, at least one USB host port 150 connected to the printed circuit board, and at least one memory device 160 connected to the printed circuit board, wherein the printed circuit board is used to connect the USB host, the in-system programming interface device, the device ports, the USB host port, and the memory device.

In all embodiments of this invention, circuits on the printed circuit board are at least used for connecting other devices in the system. In some embodiments, devices in the system can connect with each other through the circuits on the printed circuit board, but in other embodiments, devices in the system may connect with each other not through the circuits on the printed circuit board.

In some embodiments, the USB host is a single chip having logic circuits that can execute USB host functions. In other embodiments, the USB host is a chip system with many chips to accomplish USB host functions. In all embodiments of this invention, a chip is a packaged, pin-having chip or general products sold in the market.

In some embodiments, the USB host is a chip system comprising many chips of logic circuits to achieve USB host functions.

In some embodiments, the memory device is a volatile memory, non-volatile memory or a combination of two sorts of memory. In some embodiments, the memory device is used for storing a codebook that has manufacture IDs and product IDs of outside devices. In some embodiments, the outside device is a USB device. In some embodiments, the memory is used for storing drivers of outside devices.

In some embodiments, due to the SOC (System-on-Chip) technology, a chip of the USB host not only has logic circuits that can execute USB host functions, but also has memory circuits that can execute storage functions.

In some embodiments, because of the SIP (System-in-Package) technology, such as stack IC package, multi-chip module and multi-chip package, chips with USB host functions and memory chips that can execute storage functions can be packaged together to form a USB host.

Therefore, in some embodiments, due to the memory functions of the USB host, the memory device of the system may not first be installed. On the other hand, according to this invention, the memory device of the system can be defined as a memory device port used for a memory device installed.

In some embodiments, the in-system programming interface device is a programmable electronic device (for example: E2PROM, Flash) that can in-situ modify the memory device in the system of this invention or, in other embodiments, in-situ modify data (or a software) of memory circuits executing storage functions in the USB host. Through the in-system programming interface device, user can use a memory card to renew the data (or software).

In some embodiments, at least one device port is used for ethernet connection 141 to the system. Thus, the system of this invention becomes a shared hardware through the internet.

In some embodiments, at least one device port is used for USB connection 142 to the system. The device port may be called a USB port that can connect USB devices to the system of this invention.

In some embodiments, also referring to FIG. 1, the USB host port is used to connect not only a USB hub 170, but also USB devices. Thus, this invention also provides another system with USB host functions. This system comprises a printed circuit board, a USB host connected to the printed circuit board, an in-system programming interface device connected to the printed circuit board, a plurality of device ports connected to the printed circuit board, at least one USB host port connected to the printed circuit board, at least one memory device connected to the printed circuit board, and a USB hub connected to the USB host port, wherein the printed circuit board is used to connect the USB host, the in-system programming interface device, the device ports, the USB host port, and the memory device.

Besides, in some embodiments, also referring to FIG. 1, the system, also provided by this invention, comprises a printed circuit board, a USB host connected to the printed circuit board, an in-system programming interface device connected to the printed circuit board, a plurality of device ports connected to the printed circuit board, at least one USB host port connected to the printed circuit board, at least one memory device connected to the printed circuit board, a USB hub connected to the USB host port, and at least one USB device connected to the USB hub, wherein the printed circuit board is used to connect the USB host, the in-system programming interface device, the device ports, the USB host port, and the memory device.

Because the system of this invention may be operated not through a computer, thus in some embodiments, the system, also provided by this invention, comprises a printed circuit board, a USB host connected to the printed circuit board, an in-system programming interface device connected to the printed circuit board, a plurality of device ports connected to the printed circuit board, at least one USB host port connected to the printed circuit board, at least one memory device connected to the printed circuit board, and a control panel 180 connected to the printed circuit board, wherein the printed circuit board is used to connect the USB host, the in-system programming interface device, the device ports, the USB host port, and the memory device.

In some embodiments, the control panel 180 comprises a display device 181, such as CRT (cathode-ray tube), LCD (liquid crystal display), LED (light-emitted diode), plasma display, or other known or to-be-invented displays.

FIG. 2 discloses a flow diagram of a processing method of this invention to process a system with USB functions. The system comprises a printed circuit board, a USB host connected to the printed circuit board, an in-system programming interface device connected to the printed circuit board, a plurality of device ports connected to the printed circuit board, at least one USB host port connected to the printed circuit board, and at least one memory device connected to the printed circuit board, wherein the printed circuit board is used to connect the USB host, the in-system programming interface device, the device ports, the USB host port, and the memory device, and the system further comprises a control panel connected to the printed circuit board.

In some embodiments, the method of this invention comprises the following steps: (a) checking whether the USB host port is connected to an outside device; (b) if it is yes at the step (a), reading a manufacturer ID and product ID of the outside device; (c) checking whether the manufacturer ID and product ID are listed in a codebook stored in the memory device; (d) if it is yes at the step (c), showing the name of the outside device on the control panel.

In some embodiments, the method of this invention further comprises the following steps: (d1) if it is no at the step (c), showing a first signal expressing to request an operator to select a conformable model of the outside device on the control panel; (d2) check whether the conformable model can apply to the outside device.

In some embodiments, the method of this invention further comprises the following step: (d3) if it is yes at the step (d2), then continuing the step (d).

In some embodiments, the method of this invention further comprises the following steps: (d31) if it is no at the step (d2), at least showing a second signal expressing to request an operator to remove the outside device on the control panel; (d32) making the system idle.

In some embodiments, the method of this invention further comprises the following steps: (e) loading parameters required by the outside device; (f) giving a job to the outside device.

In some embodiments, the method of this invention further comprises the following step: (g) deciding whether the job from the step (f) should be executed.

In some embodiments, the method of this invention further comprises the following steps: (h) if it is yes at the step (g), executing the job from the step (f); (i) checking whether the job is finished.

In some embodiments, the method of this invention further comprises the following step: (h1) if it is no at the step (g), then making the system idle.

In some embodiments, the method of this invention further comprises the following step: (j) if it is yes at the step (i), then making the system idle.

In some embodiments, the method of this invention further comprises the following step: (j1) if it is no at the step (i), then continuing to execute the job from the step (f).

In some embodiments, the method of this invention further comprises the following step: (k) deciding whether the outside device should be removed.

In some embodiments, the method of this invention further comprises the following step: (l) if it is no at the step (k), then making the system idle.

In some embodiments, the method of this invention further comprises the following step: (l1) if it is yes at the step (k), then removing the outside device.

An example is given. After a digital camera is used for spots, a memory card installed in the digital camera is picked up. Several photograph files are stored in the memory card. The memory card is inserted into an in-system programming interface device of a system of one of the embodiments in accordance with this invention. From now on, there has been a printer connected to the system through a USB host port.

Therefore, refer to FIG. 2 again. The system starts to check whether an outside device is connected and finds that a printer is connected. Then, the system reads the manufacturer ID and product ID of the printer and checks whether the manufacturer ID and product ID are stored in the codebook of the memory device, and if it is yes, it is shown on the control panel that the outside device is a printer (or plus the manufacturer ID or product ID). It should be noted that the system is controlled by the USB host and softwares used to execute each step are stored in the memory device or memory chip (or circuits) in the host. Furthermore, drivers of devices listed in the codebook are stored in the memory device or memory chip (or circuits) in the host

Then, the parameters required by the printer are loaded, such as printed page numbers, formal printed or draft. Then, a job is given to the printer, such as print, job name. At this moment, the control panel shows the printer's status, such as waiting for printing, printing, data transmitting. Then, a printing command is given to the printer, for example: pressing the execution bottom or “Yes” option. Then, the system starts the printing operation through the printer. During this period, the system will continue to send signals to check whether the printing stops. As long as the printing stops, then the system stays idle.

If the system considers that the printed is beyond the list in the codebook, then the control panel will show an indication that will request an operator to select a conformable model of the printer. The operator can select other product IDs based on the options of the same manufacturer. Then, the system will check whether the conformable model can apply to the printer. If the conformable model can drive the printer, then the printing procedure continues. If the conformable model cannot drive the printer, then the system will stay idle.

It should be noted that in the system of this invention, the transmittance protocol can be the USB 2.0 version or 1.1 version, and any USB transmittance protocols can be used through circuit design or software. Therefore, the variety of the transmittance protocols never limits this invention.

Although this invention is disclosed in the abovementioned, preferable embodiments, they are not used to limit this invention. Any one skilled in the art, within the spirit and scope of this invention, can make any change and modification. Thus, the protection scope of this invention should be defined as the appended claims.

### BRIEF DESCRIPTION OF THE DRAWINGS

FIG. 1 shows a system of one of the embodiments in accordance with this invention.

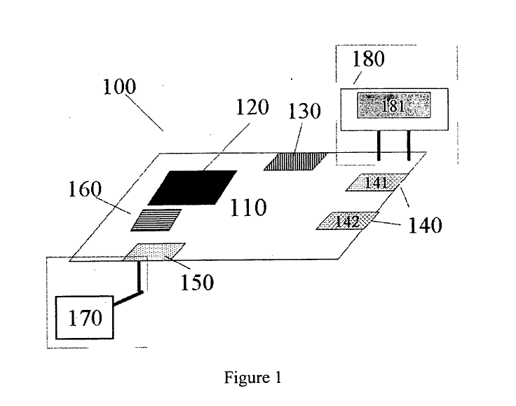

FIG. 2 shows a flow diagram of one of the embodiments in accordance with this invention.

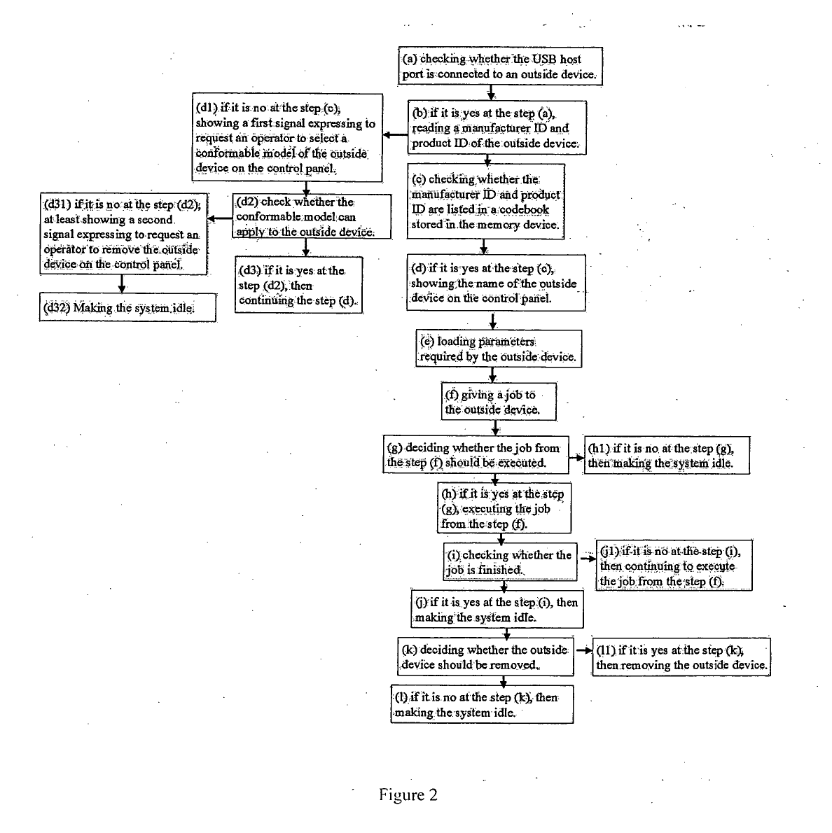

What I claim is:

1. A system with Universal Serial Bus (USB) host functions, comprising:
a printed circuit board;
a USB host connected to the printed circuit board;.
an in-system programming interface device connected to the printed circuit board;
a plurality of device ports connected to the printed circuit board;
at least one USB host port connected to the printed circuit board; and
at least one memory device connected to the printed circuit board;
wherein the printed circuit board is used to connect the USB host, the in-system programming interface device, the device ports, the USB host port, and the memory device.

2. The System of claim 1, further comprising a control panel connected to the printer circuit board.

3. The system of claim 2, wherein the control panel comprises a display device.

4. The system of claim 1, wherein at least one of the device ports is used for ethernet connection to the system.

5. The system of claim 1, wherein at least one of the device ports is used for USB connection to the system.

6. The System of claim 1, further comprising a USB hub connected to the USB host port.

7. The System of claim 6, further comprising at least one USB device connected to the USB hub.

8. A processing method for a system with USB host functions, wherein the system comprises a printed circuit board, a USB host connected to the printed circuit board, an in-system programming interface device connected to the printed circuit board, a plurality of device ports connected to the printed circuit board, at least one USB host port connected to the printed circuit board, at least one memory device connected to the printed circuit board, and a control panel, wherein the printed circuit board is used to connect the USB host, the in-system programming interface device, the device port, the USB host port, and the memory device and the control panel is connected to the printed circuit board, comprising following steps:
(a) checking whether the USB host port is connected to an outside device;
(b) if it is yes at the step (a), reading a manufacturer ID and product ID of the outside device;
(c) checking whether the manufacturer ID and product ID are listed in a codebook stored in the memory device; and
(d) if it is yes at the step (c), showing the name of the outside device on the control panel.

9. The processing method of claim 8, further comprising:
(e) loading parameters required by the outside device; and
(f) giving a job to the outside device.

10. The processing method of claim 9, further comprising:
(g) deciding whether the job from the step (f) should be executed.

11. The processing method of claim 10, further comprising:
(h) if it is yes at the step (g), executing the job from the step (f); and
(i) checking whether the job is finished.

12. The processing method of claim 10, further comprising:
(h1) if it is no at the step (g), then making the system idle.

13. The processing method of claim 11, further comprising:
(j) if it is yes at the step (i), then making the system idle.

14. The processing method of claim 11, further comprising:
(j1) if it is no at the step (i), then continuing to execute the job from the step (f).

15. The processing method of claim 13, further comprising:
(k) deciding whether the outside device should be removed.

16. The processing method of claim 15, further comprising:
(l) if it is no at the step (k), then making the system idle.

17. The processing method of claim 8, further comprising:
(d1) if it is no at the step (c), showing a first signal expressing to request an operator to select a conformable model of the outside device on the control panel; and
(d2) check whether the conformable model can apply to the outside device.

18. The processing method of claim 17, further comprising:
(d3) if it is yes at the step (d2), then continuing the step (d).

19. The processing method of claim 17, further comprising:
(d31) if it is no at the step (d2), at least showing a second signal expressing to request an operator to remove the outside device on the control panel; and
(d32) making the system idle.

20. The processing method of claim 15, further comprising:
(l1) if it is yes at the step (k), then removing the outside device.
